(19) United States
(12) Patent Application Publication
(10) Pub. No.: US 2026/0052125 A1
(43) Pub. Date: Feb. 19, 2026

(54) INDICATING SAMPLING POLICY INFORMATION USING COORDINATION MESSAGES

(71) Applicant: International Business Machines Corporation, Armonk, NY (US)

(72) Inventors: Patrick Aaron TAMBORSKI, Chicago, IL (US); Adam GRAY, Chicago, IL (US); Brian FARRELL, Chicago, IL (US)

(21) Appl. No.: 19/367,590

(22) Filed: Oct. 23, 2025

Related U.S. Application Data
(63) Continuation of application No. 18/090,041, filed on Dec. 28, 2022, now Pat. No. 12,457,199.
Application No. 18/090,041 is a continuation of application No. PCT/US22/54075, filed on Dec. 27, 2022.

(51) Int. Cl. H04L 9/40; G06F 21/53; G06F 21/64; H04L 41/12; H04L 61/3015; H04L 67/1008; H04L 67/1036

(52) U.S. Cl. CPC H04L 63/0281; G06F 21/53; G06F 21/64; H04L 61/302; H04L 63/0236; H04L 63/029; H04L 63/0823; H04L 63/083; H04L 63/0884; H04L 63/1425; H04L 63/20; H04L 67/1008; H04L 67/1036; G06F 2221/033; H04L 41/12; H04L 63/0272

(57) ABSTRACT

In some implementations, a global coordinator may receive, from a distributed storage and task processing network (DSTN) managing unit, a first coordination message that indicates currently configured sampling policy information for the DSTN managing unit. The global coordinator may transmit, to an analytics agent, the currently configured sampling policy information for the DSTN managing unit. The global coordinator may receive, from the analytics agent, adjusted sampling policy information for the DSTN managing unit. The global coordinator may transmit, to the DSTN managing unit, a second coordination message that indicates the adjusted sampling policy information for the DSTN managing unit.

### BACKGROUND

Computer networks often include multiple interconnected devices that store, process, and exchange data. These networks can be managed and monitored to ensure they operate efficiently and effectively.

### SUMMARY

Some aspects described herein relate to a method. The method may include receiving, by a global coordinator and from a distributed storage and task processing network (DSTN) managing unit, a first coordination message that indicates currently configured sampling policy information for the DSTN managing unit. The method may include transmitting, by the global coordinator and to an analytics agent, the currently configured sampling policy information for the DSTN managing unit. The method may include receiving, by the global coordinator and from the analytics agent, adjusted sampling policy information for the DSTN managing unit. The method may include transmitting, by the global coordinator and to the DSTN managing unit, a second coordination message that indicates the adjusted sampling policy information for the DSTN managing unit.

Some aspects described herein relate to a computer system. The computer system may include a processor set, one or more computer-readable storage media, and program instructions stored on the one or more computer-readable storage media to cause the processor set to perform operations. The operations may include receiving, from a DSTN managing unit, a first coordination message that indicates currently configured sampling policy information for the DSTN managing unit. The operations may include transmitting, to an analytics agent, the currently configured sampling policy information for the DSTN managing unit. The operations may include receiving, from the analytics agent, adjusted sampling policy information for the DSTN managing unit. The operations may include transmitting, to the DSTN managing unit, a second coordination message that indicates the adjusted sampling policy information for the DSTN managing unit.

Some aspects described herein relate to a computer program product. The computer program product may include one or more computer-readable storage media and program instructions stored on the one or more computer-readable storage media to perform operations. The operations may include receiving, from a DSTN managing unit, a first coordination message that indicates currently configured sampling policy information for the DSTN managing unit. The operations may include transmitting, to an analytics agent, the currently configured sampling policy information for the DSTN managing unit. The operations may include receiving, from the analytics agent, adjusted sampling policy information for the DSTN managing unit. The operations may include transmitting, to the DSTN managing unit, a second coordination message that indicates the adjusted sampling policy information for the DSTN managing unit.

### BRIEF DESCRIPTION OF THE DRAWINGS

FIG. 1 is a diagram of an example computing environment for indicating sampling policy information using coordination messages.

FIG. 2 is a schematic block diagram of an implementation of a distributed storage network.

FIG. 3 is a diagram illustrating an example of a global coordinator system according to various implementations.

FIG. 4 is a diagram of an example implementation associated with coordination messages transmitted between a DSTN managing unit and a global coordinator.

FIG. 5 is a diagram of an example implementation associated with indicating sampling policy information using coordination messages.

FIG. 6 is a diagram of example components of a device associated with indicating sampling policy information using coordination messages.

FIG. 7 is a flowchart of an example process associated with indicating sampling policy information using coordination messages.

### DETAILED DESCRIPTION

The following detailed description of example implementations refers to the accompanying drawings. The same reference numbers in different drawings may identify the same or similar elements.

Computing devices are known to communicate data, process data, and/or store data. Such computing devices range from wireless smart phones, laptops, tablets, personal computers (PCs), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

In some examples, a computer may effectively extend its CPU by using “cloud computing” to perform one or more computing functions (e.g., a service, an application, an algorithm, an arithmetic logic function, or the like) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers. In addition to cloud computing, a computer may use “cloud storage” as part of its memory system. Cloud storage enables a user, via its computer, to store files, applications, or the like, on an internet storage system. The internet storage system may include a redundant array of independent disks (RAID) system and/or a dispersed storage system that uses an error correction scheme to encode data for storage.

In some examples, cloud storage system or similar system may be associated with a distributed storage network (DSN). A DSN includes multiple distributed computing systems including DSN memories. The DSN memories include DSTN managing units. The DSTN managing units initiate connections with a coordination unit that is part of the DSN by periodically sending messages to the coordination unit. The coordination unit transmits a coordination message to each DSTN managing unit that initiates a connection. Each of the DSTN managing units processes the coordination message, in some cases assisting in completion of tasks indicated in the coordination message, and transmits a response to the coordination unit. The coordination unit makes the responses from the DSTN managing units available for use by other applications. A coordination unit that accepts connections from all DSNs is defined as the “global coordinator. ” In some examples, a global coordinator can, as part of the coordination message, can collect metadata that describes a view of each DSN's state. “State” may include elements like network health, process health, device health, or the like. The global coordinator may include or otherwise be associated with an analytics agent that can process metadata and identify problems based on a compiled knowledge base.

DSNs have become increasingly complex, generating vast amounts of telemetry data that may need to be collected, processed, and analyzed to ensure optimal performance. Telemetry data provides valuable insights into the state of a system, enabling administrators to identify performance bottlenecks, errors, and areas for improvement. However, the sheer volume of telemetry data generated by DSNs poses significant challenges for efficient data collection and analysis.

One of the primary challenges in telemetry data collection is determining the optimal sampling policy. A sampling policy defines how telemetry data is collected, including the frequency, type, and scope of data collection. A well-designed sampling policy may ensure that the collected data is representative of the system's behavior and provides actionable insights. However, designing an effective sampling policy can be a daunting task, particularly in large-scale DSNs with diverse workloads and configurations.

Currently, sampling policies are often statically configured, relying on manual tuning and expertise to adjust the policy parameters. This approach has several limitations, including the potential for human error, the need for continuous monitoring and adjustments, and the risk of missing critical events or trends. Furthermore, static sampling policies may not adapt well to changing system conditions, such as shifting workloads or hardware failures. This may result in ineffective sampling policies and thus inefficient use of power, computing, and network resources.

Some implementations described herein provide a global coordinator that drives adaptive sampling policies for DSNs. For example, some implementations and techniques described herein are directed to a global coordinator that receives, from a DSTN managing unit, a coordination message that includes currently configured sampling policy information for that DSTN managing unit. The global coordinator may then transmit this information to an analytics agent, which in turn provides adjusted sampling policy information for the DSTN managing unit. The global coordinator may thus transmit the adjusted sampling policy information to the DSTN managing unit via a second coordination message.

In some implementations, the global coordinator may aggregate sampling policy information from multiple DSTN managing units, resulting in aggregated sampling policy information. The global coordinator may provide the aggregated sampling policy information to the analytics agent, and thus the adjusted sampling policy information may be based on the aggregated sampling policy information. The global coordinator may also report the aggregated sampling policy information to a user (e.g., DSN operator), such as via a user interface.

In this way, the global coordinator may adaptively adjust sampling policies for multiple DSTN managing units, thereby optimizing telemetry data transmission rates, reducing network congestion, and conserving network resources. Additionally, the global coordinator may conserve processing resources, memory resources, network resources, and/or the like by minimizing the collection and transmission of unnecessary telemetry data, reducing the computational load associated with processing telemetry data, and preventing errors caused by incorrect or outdated sampling policies.

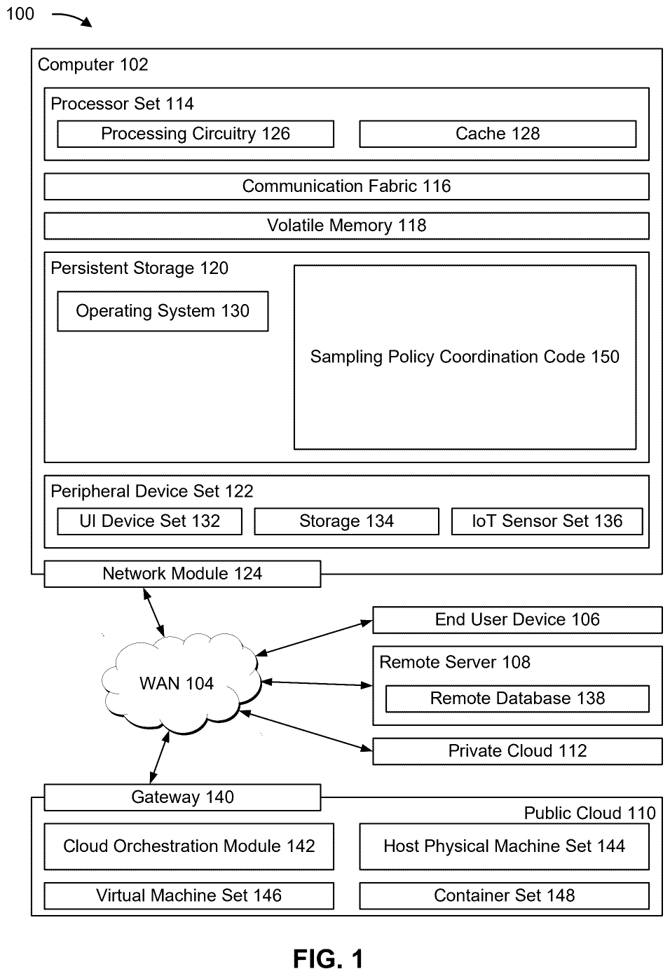

FIG. 1 is a diagram of an example computing environment 100 for indicating sampling policy information using coordination messages, as described herein.

The computing environment 100 contains an example of an environment for the execution of at least some of the computer code involved in performing the inventive methods, such as sampling policy coordination code 150. In addition to the sampling policy coordination code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the sampling policy coordination code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

The processor set 114 includes one, or more, computer processors of any type now known or to be developed in the future. The processing circuitry 126 may be distributed over multiple packages, for example, multiple, coordinated integrated circuit chips. The processing circuitry 126 may implement multiple processor threads and/or multiple processor cores. The cache 128 is memory that is located in the processor chip package(s) and is typically used for data or code that should be available for rapid access by the threads or cores running on the processor set 114. Cache memories are typically organized into multiple levels depending upon relative proximity to the processing circuitry. Alternatively, some, or all, of the cache for the processor set may be located “off chip. ” In some computing environments, the processor set 114 may be designed for working with qubits and performing quantum computing. Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in sampling policy coordination code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read only memory (ROM), but typically at least a portion of the persistent storage allows writing of data, deletion of data and re-writing of data. Some familiar forms of persistent storage include magnetic disks and solid state storage devices. The operating system 130 may take several forms, such as various known proprietary operating systems or open source Portable Operating System Interface-type operating systems that employ a kernel. The code included in the sampling policy coordination code 150 typically includes at least some of the computer code involved in performing one or more operations described herein. The operations may include, for example, receiving, from a DSTN managing unit, a first coordination message that indicates currently configured sampling policy information for the DSTN managing unit; transmitting, to an analytics agent, the currently configured sampling policy information for the DSTN managing unit; receiving, from the analytics agent, adjusted sampling policy information for the DSTN managing unit; and transmitting, to the DSTN managing unit, a second coordination message that indicates the adjusted sampling policy information for the DSTN managing unit.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images. ” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

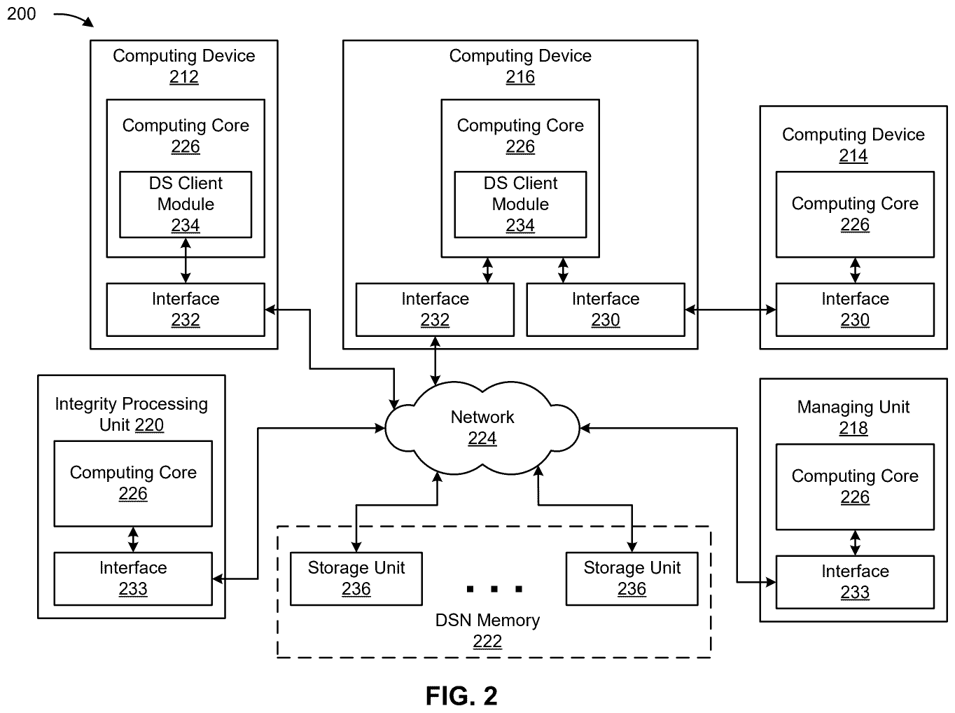

FIG. 2 is a schematic block diagram of an example implementation of a DSN 200. As shown in FIG. 2, the DSN 200 includes a plurality of computing devices (shown as computing device 212, computing device 214, and computing device 216), a DSTN managing unit 218 (sometimes referred to herein simply as “managing unit” for ease of description), an integrity processing unit 220, and a DSN memory 222. The components of the DSN 200 are coupled to a network 224, which may include one or more wireless and/or wire lined communication systems, one or more non-public intranet systems and/or public internet systems, and/or one or more LANs and/or WANs.

The DSN memory 222 includes a plurality of storage units 236 that may be located at geographically different sites (e.g., one in Chicago, one in Milwaukee, or the like), at a common site, or a combination thereof. For example, if the DSN memory 222 includes eight storage units 236, each storage unit 236 may be located at a different site. As another example, if the DSN memory 222 includes eight storage units 236, all eight storage units 236 may be located at the same site. As yet another example, if the DSN memory 222 includes eight storage units 236, a first pair of storage units 236 may be at a first common site, a second pair of storage units 236 may be at a second common site, a third pair of storage units 236 may be at a third common site, and a fourth pair of storage units 236 may be at a fourth common site. In some other implementations, a DSN memory 222 may include more or fewer than eight storage units 236. Each storage unit 236 includes a computing core or components thereof and a plurality of memory devices for storing dispersed error encoded data.

Each of the computing devices 212, 214, 216, the DSTN managing unit 218, and the integrity processing unit 220 include a computing core 226, which includes network interfaces (shown in FIG. 2 as network interface 230, network interface 232, and network interface 233). Computing devices 212, 214, 216 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a PC, a computer server, a cable set-top box, a satellite receiver, a television set, a printer, a fax machine, home entertainment equipment, a video game console, and/or any type of home or office computing equipment. Each of the DSTN managing unit 218 and the integrity processing unit 220 may be separate computing devices, may be a common computing device, and/or may be integrated into one or more of the computing devices 212, 214, 216 and/or into one or more of the storage units 236.

Each network interface 230, 232, 233 includes software and hardware to support one or more communication links via the network 224 indirectly and/or directly. For example, network interface 230 supports a communication link (e.g., wired, wireless, direct, via a LAN, via the network 224, or the like) between computing devices 214 and 216. As another example, network interface 232 supports communication links (e.g., a wired connection, a wireless connection, a LAN connection, and/or any other type of connection to/from the network 224) between computing devices 212, 216 and the DSN memory 222. As yet another example, network interface 233 supports a communication link for each of the DSTN managing unit 218 and the integrity processing unit 220 to the network 224.

Computing devices 212, 216 include a dispersed storage (DS) client module 234, which enables the computing device 212, 216 to DS error encode and decode data. In this example implementation, computing device 216 functions as a DS processing agent for computing device 214. In this role, computing device 216 DS error encodes and decodes data on behalf of computing device 214.

With the use of DS error encoding and decoding, the DSN 200 is tolerant of a significant number of storage unit failures (the number of failures is based on parameters of the DS error encoding function) without loss of data and without the need for a redundant or backup copies of the data. Further, the DSN 200 stores data for an indefinite period of time without data loss and in a secure manner (e.g., the system is very resistant to unauthorized attempts at accessing the data). When a computing device 212, 216 has data to store, the computing device 212, 216 DS error encodes the data in accordance with a DS error encoding process based on DS error encoding parameters. The DS error encoding parameters include an encoding function (e.g., information dispersal algorithm, Reed-Solomon, Cauchy Reed-Solomon, systematic encoding, non-systematic encoding, on-line codes, or the like), a data segmenting protocol (e.g., data segment size, fixed, variable, or the like), and per data segment encoding values. The per data segment encoding values include a total, or pillar width, number (T) of encoded data slices per encoding of a data segment (e.g., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The DS error encoding parameters may further include slicing information (e.g., the number of encoded data slices that will be created for each data segment) and/or slice security information (e.g., per encoded data slice encryption, compression, integrity checksum, or the like).

In some examples, the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 212, 216 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol. The computing device 212, 216 then disperse storage error encodes a data segment using the selected encoding function (e.g., Cauchy Reed-Solomon) to produce a set of encoded data slices.

The computing device also creates a slice name (SN) for each encoded data slice (EDS) in the set of encoded data slices. The slice name (SN) includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 222. As a result of encoding, the computing device 212, 216 produces a plurality of sets of encoded data slices, which are provided with their respective slice names to the storage units for storage.

The integrity processing unit 220 performs rebuilding of “bad” or missing encoded data slices. At a high level, the integrity processing unit 220 performs rebuilding by periodically attempting to retrieve/list encoded data slices, and/or slice names of the encoded data slices, from the DSN memory 222. For retrieved encoded slices, they are checked for errors due to data corruption, outdated version, or the like. If a slice includes an error, the slice is flagged as a “bad” slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 222.

FIG. 2 is provided as an example. Other examples may differ from what is described with regard to FIG. 2.

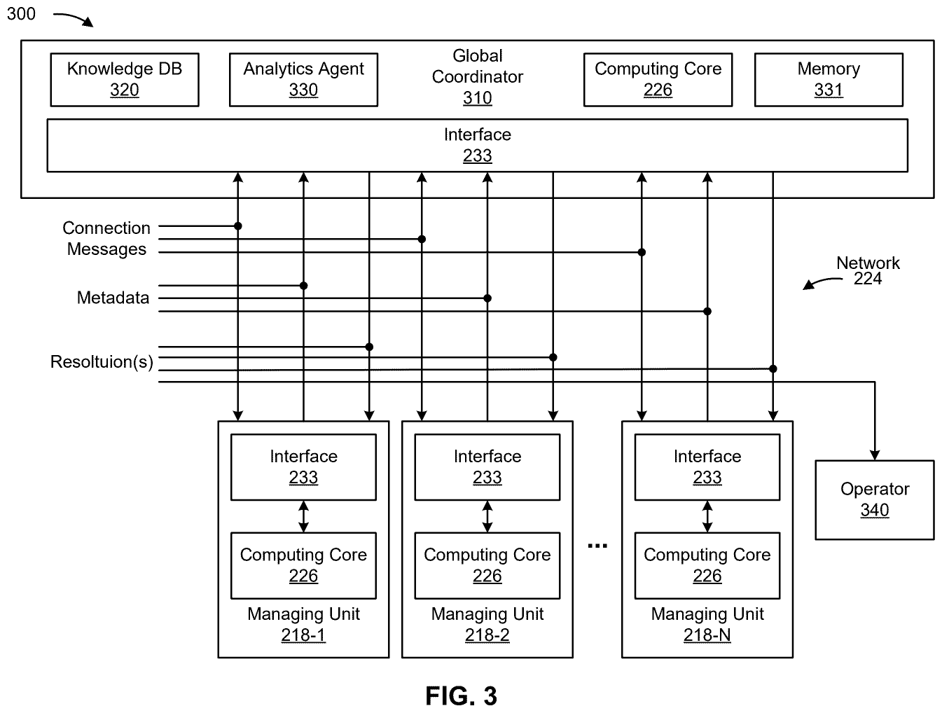

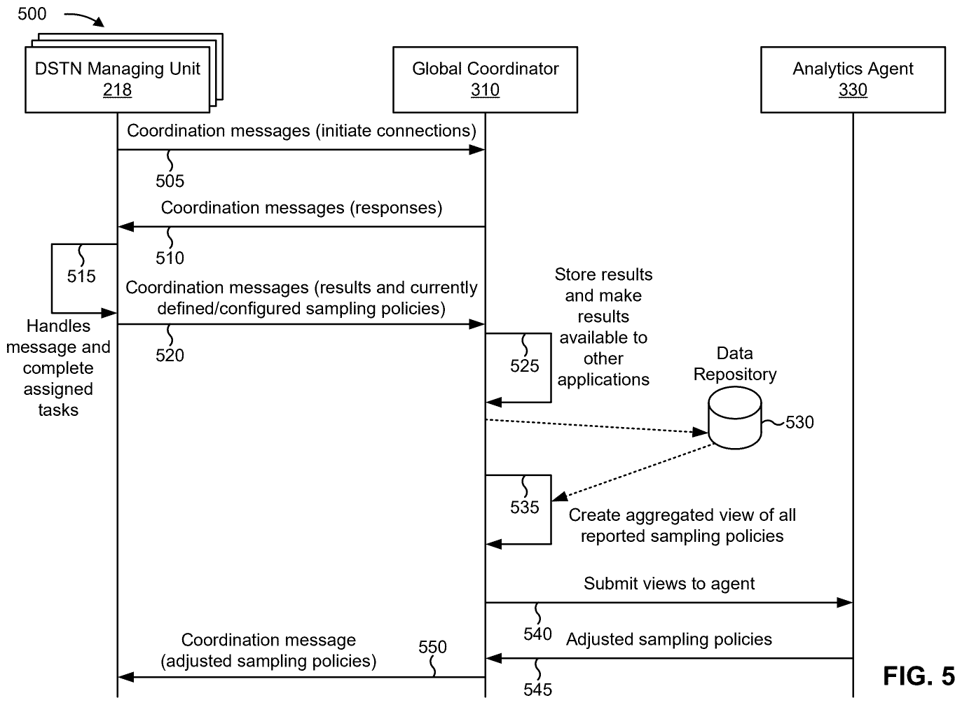

FIG. 3 is a diagram illustrating an example of a global coordinator system 300 according to various implementations. In some implementations, a DSN 200 includes multiple distributed computing systems including DSN memories 222, as described above in connection with FIG. 2. In some implementations, the DSN memories 222 also include DSTN managing units 218 (shown in FIG. 3 as a first DSTN managing unit 218-1 through an N^{th} DSTN managing unit 218-N), as described above in connection with FIG. 2. The DSTN managing units 218 initiate periodic connections with a global coordinator 310 that is part of the DSN 200 by sending/receiving coordination messages. The global coordinator 310 (sometimes referred to herein as a “coordination unit”) includes a computing device with a network interface 233, computing core 226, knowledge database 320, analytics agent 330 (sometimes referred to herein as an “analytics entity” or an “analytics processor”), and memory 331. The coordination messages, in addition to creating a communications session, may also include metadata provided by the DSTN managing units 218. For example, as described in more detail below in connection with FIG. 5, in some implementations the coordination messages include sampling policy information (e.g., currently configured or defined sampling policy information, adjusted or reconfigured sampling policy information, or similar sampling policy information).

The analytics agent 330 processes the metadata received in the coordination messages by comparing the received metadata to previously stored metadata and/or to determine any adjustments that should be made to the sampling policies. These adjustments (sometimes referred to herein as “resolutions”) may be returned to the DSTN managing units 218 to execute (e.g., process corrective actions). Each of the DSTN managing units 218 processes the coordination messages, in some cases assisting in completion of tasks indicated in the coordination message and return (e.g., transmit) a response (e.g., memory status, updates, communication status, performance metrics, or the like) to the global coordinator 310. In some implementations, the global coordinator 310 designates the responses from the DSTN managing units 218 as available for use by other applications.

In operation, the DSTN managing unit 218 performs DS management services. For example, the DSTN managing unit 218 establishes distributed data storage parameters (e.g., vault creation, distributed storage parameters, security parameters, billing information, user profile information, or the like) for computing devices 212, 214 individually or as part of a group of user devices. As a specific example, the DSTN managing unit 218 coordinates creation of a vault (e.g., a virtual memory block associated with a portion of an overall namespace of the DSN 200) within the DSN memory 222 for a user device, a group of devices, or for public access and establishes per vault DS error encoding parameters for a vault. The DSTN managing unit 218 facilitates storage of DS error encoding parameters for each vault by updating registry information of the DSN 200, where the registry information may be stored in the DSN memory 222, a computing device 212, 214, 216, the DSTN managing unit 218, and/or the integrity processing unit 220.

The DSTN managing unit 218 creates and stores user profile information (e.g., an access control list (ACL)) in local memory and/or within memory of the DSN memory 222. The user profile information includes authentication information, permissions, and/or security parameters. The security parameters may include encryption/decryption scheme, one or more encryption keys, key generation scheme, and/or data encoding/decoding scheme.

The DSTN managing unit 218 creates billing information for a particular user, a user group, a vault access, public vault access, or the like. For instance, the DSTN managing unit 218 tracks the number of times a user accesses a non-public vault and/or public vaults, which can be used to generate per-access billing information. In another instance, the DSTN managing unit 218 tracks the amount of data stored and/or retrieved by a user device and/or a user group, which can be used to generate per-data-amount billing information.

As another example, the DSTN managing unit 218 performs network operations, network administration, and/or network maintenance. Network operations include authenticating user data allocation requests (e.g., read and/or write requests), managing creation of vaults, establishing authentication credentials for user devices, adding/deleting components (e.g., user devices, storage units, and/or computing devices with a DS client module 234) to/from the DSN 200, and/or establishing authentication credentials for the storage units 236. Network administration includes monitoring devices and/or units for failures, maintaining vault information, determining device and/or unit activation status, determining device and/or unit loading, and/or determining any other system level operation that affects the performance level of the DSN 200. Network maintenance includes facilitating replacing, upgrading, repairing, and/or expanding a device and/or unit of the DSN 200.

In some implementations, analytics agent 330 includes artificial intelligence (AI) to discern or set sampling policies for the one or more DSTN managing units 218. For example, the analytics agent 330 may use any suitable machine learning (ML) techniques, such as deep learning techniques, to populate the knowledge database 320 and/or provide the AI necessary to set sampling policies based on the metadata.

If the DSTN managing unit 218 is configured to accept automatic resolutions, a DSTN managing unit 218 applies them (e.g., the DSTN managing unit 218 executes resolution steps). In this case, operator interaction with the DSTN managing unit 218 is not required. Once applied, the DSTN managing unit 218 may either apply the resolution locally or distribute it across all affected internal nodes. However, if the DSTN managing unit 218 is not configured to accept these automatic resolutions, the DSTN managing unit 218 may leave them intact and may wait for a user (e.g., operator 340) verification. Alerts may be generated and targeted towards support staff (e.g., operators 340) that are assigned to a particular DSN 200.

In one example configuration, an automatic resolution may be an “on-demand” memory upgrade that is further distributed to individual clusters in the DSN 200. In some examples, the information (e.g., resolution) sent back to the DSTN managing unit 218 may also be a notice that more storage is required. The DSTN managing unit 218 may be configured that, when the global coordinator 310 determines that storage will reach X % (with X being close to 100) within a short time-frame, new storage is automatically added (e.g., mapped, purchased, or the like), and the global coordinator 310 handles various details like storage requirements, performance requirements, model, number of drives, addressing, access, level of security, or the like. This may all be driven through a canned list of configuration options for the global coordinator 310. Additionally, or alternatively, the global coordinator 310 may notify sales personnel to contact a customer under these conditions as well.

FIG. 3 is provided as an example. Other examples may differ from what is described with regard to FIG. 3.

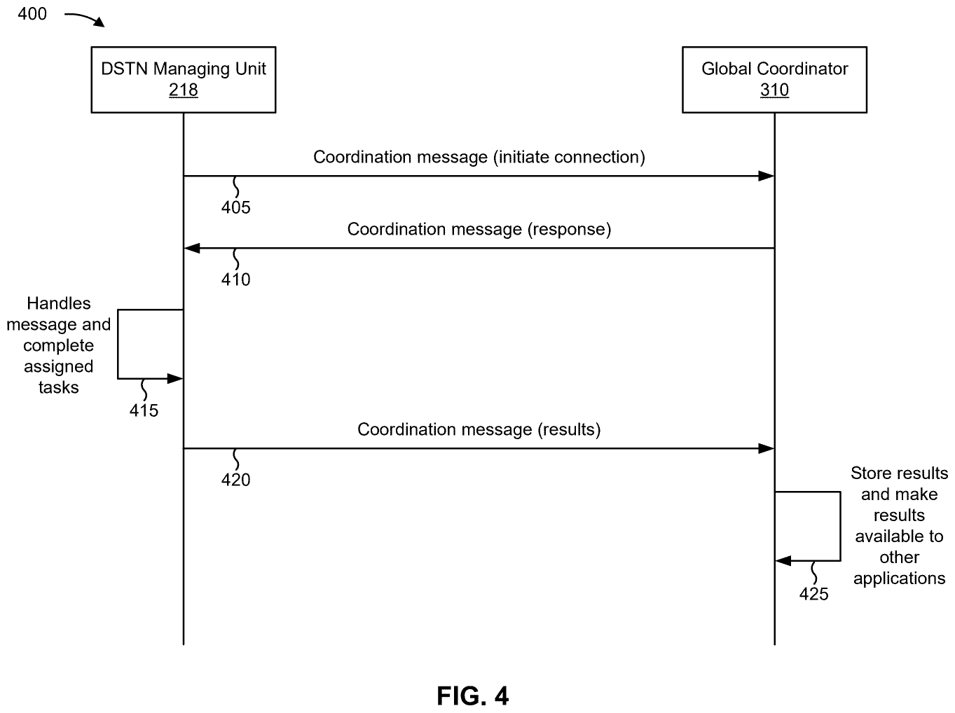

FIG. 4 is a diagram of an example implementation 400 associated with coordination messages transmitted between a DSTN managing unit 218 and a global coordinator 310.

As described above in connection with FIG. 3, in some implementations a DSTN managing unit 218 initiates connections with a global coordinator 310 (e.g., a coordination unit) that is part of the DSN 200 by periodically sending messages to the global coordinator 310. More particularly, as indicated by reference number 405, the DSTN managing unit 218 may transmit, and the global coordinator 310 may receive, a first coordination message that is used to initiate a connection between the DSTN managing unit 218 and the global coordinator 310. As indicated by reference number 410, the global coordinator 310 may transmit, and the DSTN managing unit 218 may receive, a second coordination message that is responsive to the first coordination message and that establishes the connection between the DSTN managing unit 218 and the global coordinator 310.

As indicated by reference number 415, the DSTN managing unit 218 may process the coordination message received from the global coordinator and, in some implementations, may complete tasks indicated in the coordination message. As indicated by reference number 420, the DSTN managing unit 218 transmits, and the global coordinator 310 receives, a third coordination message that is responsive to the second coordination message sent by the global coordinator 310. The third coordination message may include results of any tasks assigned to the DSTN managing unit 218, among other information. As indicated by reference number 425, the global coordinator 310 may store the results received from the DSTN managing unit 218. Additionally, or alternatively, and further shown by reference number 425, the global coordinator 310 makes the responses from the DSTN managing unit 218 available for use by other applications. In some implementations, the coordination message shown in connection with reference number 420 may include metadata that describes a view of the DSTN managing unit 218's state. “State” may include elements like network health, process health, device health, or the like. In such implementation, the global coordinator 310 may provide the metadata to the analytics agent 330, which in turn may process metadata and identify problems based on a compiled knowledge database, among other examples.

In some examples, collecting, processing, and analyzing telemetry signals from distributed applications or systems (such as from DSTN managing units 218) has become of great importance. For example, software of all kinds may be instrumented in such a way that telemetry is generated about the performance of a flow, operation, function, end-to-end network request, service call, or similar information. Other types of telemetry may capture execution rate, error rate, events, or in general something of note that happens. The components capturing signals, post-processing the signals, and sending the signals downstream may be described as a telemetry pipeline. The telemetry pipeline sends telemetry that is analyzed by other pieces of software (e.g., a telemetry back-end) to generate visualizations (e.g., dashboards), reports, alerts, or similar information. In some examples, this data may be introspected by human administrators (e.g., operators 340) for general purpose monitoring, observing, and understanding of overall system performance, among other examples.

In some implementations and techniques described herein, the coordination messages described above may thus be modified to include active/current/existing telemetry sampling policies. For example, currently configured sampling policy information may be included as metadata in a coordination message transmitted by the DSTN managing unit 218 to the global coordinator 310. This metadata may be leveraged by the global coordinator 310's analytics agent (e.g., analytics agent 330) to adjust the reported sampling policy and propagate the adjusted sampling back down to the managed DSN (e.g., to the DSTN managing units 218). This may be advantageous because the data used to feed the analytics agent 330 may come from multiple distinct DSTN managing units 218 or even multiple DSNs 200. Additionally, or alternatively, the global coordinator 310 may publish the adjusted sampling policies to end users (e.g., operators 340) along with the evidence acquired (e.g., the metadata collected as part of the coordination messages) that resulted in the adjusted sampling policies. This information may thus be used by the operator 340, such as for a purpose of fine tuning any adjustment policy details on the global coordinator 310. Aspects of including sampling policy information in one or more coordination messages are described in more detail below in connection with FIG. 5.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

FIG. 5 is a diagram of an example implementation 500 associated with indicating sampling policy information using coordination messages. As shown in FIG. 5, example implementation 500 includes one or more DSTN managing units 218, a global coordinator 310, and an analytics agent 330. In some implementations, the analytics agent 330 may be part f the global coordinator 310, as described above in connection with FIG. 3. Moreover, in implementations in which the one or more DSTN managing units 218 include multiple DSTN managing units 218, the DSTN managing units 218 may be associated with multiple DSNs 200. For example, a first DSTN managing unit 218 may be associated with a first DSN 200, and a second DSTN managing unit 218 may be associated with a second DSN 200 that is different from the first DSN 200. Additionally, or alternatively, in implementations in which the one or more DSTN managing units 218 include multiple DSTN managing units 218, the DSTN managing units 218 may be associated with multiple vendors. For example, a first DSTN managing unit 218 may be associated with a first vendor, and a second DSTN managing unit 218 may be associated with a second vendor different from the first vendor. Put another way, the global coordinator 310 may not be restricted to accepting connections from DSTN managing units 218 from the same vendor, and/or other embodiments of DSNs 200, or storage networks in general, may choose to initiate connections with the global coordinator 310, among other examples.

As indicated by reference number 505, one or more DSTN managing units 218 may transmit, and the global coordinator 310 may receive, one or more coordination messages that are used to initiate respective connections with the one or more DSTN managing units 218. In that regard, the messages shown in connection with reference number 505 may be substantially similar to the message described above in connection with reference number 405. As indicated by reference number 510, the global coordinator 310 may transmit, and the one or more DSTN managing units 218 may receive, one or more coordination messages that are responsive to the one or more coordination messages shown connection with reference number 505 and that establish the respective connections between the one or more DSTN managing units 218 and the global coordinator 310. In that regard, the messages shown in connection with reference number 510 may be substantially similar to the message described above in connection with reference number 410.

As indicated by reference number 515, the one or more DSTN managing units 218 may process the one or more coordination messages received from the global coordinator 310 and, in some implementations, the one or more DSTN managing units 218 may complete tasks indicated by the one or more coordination messages. In that regard, the operations shown in connection with reference number 515 may be substantially similar to the operations described above in connection with reference number 415. Moreover, as indicated by reference number 520, the one or more DSTN managing units 218 may transmit, and the global coordinator 310 may receive, one or more coordination message that are responsive to the one or more coordination messages shown in connection with reference number 510. In some implementations, the one or more coordination messages shown in connection with reference number 520 may include results of any tasks assigned to the one or more DSTN managing units 218, in a similar manner as described above in connection with reference number 420.

In this implementation, however, the coordination messages shown in connection with reference number 520 may indicate (e.g., via metadata associated with the coordination messages) currently configured sampling policy information for the one or more DSTN managing units 218. Put another way, the coordination message described above in connection with reference number 420 may be modified to include the current state and/or view of operator defined telemetry sampling policies or any localized (e.g., DSN specific) sampling policy. In some implementations, the currently configured sampling policy information may indicate an initial sampling policy for the DSTN managing unit 218 (e.g., an sampling policy implemented prior to any adjustments as described herein). An initial sampling policy may be configured at a DSTN managing unit 218 in various ways. In some implementations, the initial sampling policy may be set by the DSTN managing unit 218 independently of the global coordinator 310. In some other implementations, the global coordinator 310 may set the initial sampling policy for the DSTN managing unit 218. Additionally, or alternatively, the initial sampling policy may be based on default settings, operator input, or other factors.

In some implementations, the currently configured sampling policy information may indicate one or more parameters associated with a sampling policy at a respective DSTN managing unit 218, such as an interval for metric collection, types of metrics collected, a metric collection ratio, a type of metadata for which metrics are to be collected, a type of user for which metrics are to be collected, or a type of operation for which metrics are to be collected, among other information. Put another way, attributes that may be associated with a telemetry sampling policy include an interval for metric collection, the types of telemetry collected, a ratio describing how much of other types of telemetry to collect (e.g., logs, traces, or the like), whether telemetry with specific metadata (e.g., telemetry describing errors driven by http status code) should be always sampled, to include or exclude (with greater or lesser frequency) telemetry associated with specific users or operations are underway, or similar attributes.

The interval for metric collection may specify how frequently metrics are collected, such as every 15 seconds or every minute. The types of metrics collected may include metrics such as execution rate, error rate, and events. The metric collection ratio may specify the proportion of telemetry data that is collected, such as 10% or 50%. The type of metadata for which metrics are to be collected may include metadata such as user ID, request ID, or other relevant metadata. The type of user for which metrics are to be collected may specify the type of users for which telemetry data is collected, such as administrators or end-users. The type of operation for which metrics are to be collected may specify the type of operations for which telemetry data is collected, such as read or write operations.

In some examples, the coordination messages described above may be formatted according to a predefined protocol, and/or the coordination messages may include a header section, a payload section, and a footer section. The header section may include information about the source and destination of the message, the type of message, and a timestamp, among other examples. The payload section may include the sampling policy information, which may be encoded in a binary format. The footer section may include error-checking information and a digital signature, among other examples. Additionally, or alternatively, the sampling policy information may be structured according to a predefined schema, which includes fields for the sampling rate, the type of data being sampled, and the desired level of accuracy, among other information. Additionally, or alternatively, the schema may includes fields for metadata, such as the timestamp and the source of the sampling policy information, among other information.

As indicated by reference number 525, the global coordinator 310 may store any results indicated by the one or more coordination messages described above in connection with reference number 520 and/or the global coordinator 310 may make the results available to other applications, among other examples. In some implementations, the global coordinator 310 may do so by storing the results (including the sampling policy information described above) in a data repository 530, such as an object store or similar repository. Put another way, the global coordinator 310 may extract the current DSN sampling policy metadata from each coordination message and/or the global coordinator 310 may add the DSN sampling policy metadata to the data repository 530 (e.g., a simple object store, as sampling policy metadata may be represented as a document and/or object, among other examples).

More particularly, in some implementations, the data repository 530 may be implemented as a simple object store, where the telemetry sampling policies are stored as documents or objects. This may enable efficient querying and retrieval of the sampling policies. Additionally, or alternatively, the data repository 530 may be a distributed database or a centralized store. Any suitable data storage technology may be used to store the telemetry sampling policies. The data repository 530 may also be used to store other metadata, such as DSN workload information, hardware characteristics, and drive performance metrics, which may be used by the global coordinator 310 and/or analytics agent 330 to inform policy adjustment decisions.

Additionally, or alternatively, and as indicated by reference number 535, the global coordinator 310 may create an aggregated view of all reported sampling policies. More particularly, the global coordinator 310 may aggregate the currently configured sampling policy information for the one or more other DSTN managing units 218, resulting in aggregated sampling policy information. In some implementations, the global coordinator 310 may aggregate the sampling policy information from multiple DSTN managing units 218 using a weighted average algorithm, where the weights are based on the reliability and accuracy of the sampling policy information from each DSTN managing unit 218, among other examples.

In some implementations, the global coordinator 310 may, for each attribute defined in a reported telemetry sampling policy, create an aggregated view for that attribute. For example, the global coordinator 310 may identify how many DSNs 200 have specific intervals for metric collector (which, in some implementations, may be defined as a range, such as 15 seconds to 30 seconds, among other examples). Additionally, or alternatively, the global coordinator 310 may identify the number of DSNs 200 exporting certain types of telemetry. Moreover, the global coordinator 310 may identify how many DSNs 200 have a certain ratio or ratio range that describes probability of telemetry type export. Additionally, or alternatively, the global coordinator 310 may identify how many DSNs 200 are making telemetry sampling decisions based on metadata, or similar information, such as by making fine-grained or coarse-grained aggregate views (e.g., identifying subgroups of specific metadata keys or else making a view that represents the number of DSNs 200 that have a policy based on some piece of metadata). Furthermore, the global coordinator 310 may identify how many DSNs 200 are excluding/including telemetry associated with users/operations, such as by making fine-grained or coarse-grained aggregate views.

Additionally, or alternatively, the global coordinator 310 may aggregate metrics across reporting storage networks (e.g., across various DSNs 200), find similar characteristics from included metadata, and asses utility of adjusted sampling policies of multiple cloud environments based on user requirements. In some implementations, the aggregate results may be exposed by the global coordinator 310 as a service. That is, the global coordinator 310 may report (e.g., using a user interface, such as a web application or similar interface) the aggregated sampling policy information, among other information.

As indicated by reference number 540, the global coordinator 310 may transmit, and the analytics agent 330 may receive, the currently configured sampling policy information for at least one DSTN managing unit 218. In aspects in which the global coordinator 310 aggregates the currently configured sampling policy information for multiple DSTN managing units 218 (as described above in connection with reference number 535), the global coordinator 310 may transmit the aggregated sampling policy information to the analytics agent 330. Put another way, the global coordinator 310 may be capable of extracting the sampling policy information from the one or more coordination messages received from the one or more DSTN managing units 218, aggregating the sampling policy information, and submitting the aggregated sampling policy information to the analytics agent 330.

As indicated by reference number 545, the analytics agent 330 may transmit, and the global coordinator 310 may receive, adjusted sampling policy information for the one or more DSTN managing unit 218 (e.g., updated sampling policy information that is based on the aggregate view of the sampling policy information received from the one or more DSTN managing units 218). Put another way, the analytics agent 330, using the aggregated views continuously constructed by the global coordinator 310, may choose to adjust or modify a currently configured sampling policy indicated in a coordination message (e.g., the coordination message shown in connection with reference number 520) based on various factors and/or characteristics. In some implementations, the analytics agent 330 may adjust the sampling policy information using a ML model, where the model is trained on historical data and takes into account factors such as the type of data being sampled, the sampling rate, and the desired level of accuracy, among other examples.

In some implementations, the factors and/or characteristics used to determine whether a sampling policy is to be adjusted may include a most common telemetry included or excluded across all DSNs 200 as an operation is underway. Additionally, or alternatively, factors and/or characteristics used to determine whether a sampling policy is to be adjusted may include a most common scrape interval that matches DSN 200 workload, hardware, and/or drive characteristics. Moreover, factors and/or characteristics used to determine whether a sampling policy is to be adjusted may include a most common ratio and/or probability used to decide if telemetry is sampled that matches DSN 200 workload, hardware, and/or drive characteristics and/or process state. Additionally, or alternatively, the factors and/or characteristics used to determine whether a sampling policy is to be adjusted may include the most common “sub groups” of metadata keys used in sampling decisions that matches reporting DSN 200 workload, hardware, and/or drive characteristics, among other information.

In this regard, the global coordinator 310 and/or the analytics agent 330 may be capable of constructing a suggested and/or recommended telemetry sampling policy by introspecting collected policies for each DSTN managing unit 218 in the data repository 530 along with other collected metadata. In some implementations, constructing a suggested and/or recommended telemetry sampling policy may be rule-based and/or based on patterns discovered by humans, may be ML based, or may be based on other methods. Additionally, or alternatively, the global coordinator 310 may store suggested and/or recommended sampling policies for future use, such as for on-boarding DSNs 200 with similar characteristics, among other examples.

As described above, in some implementations the global coordinator 310 may be capable of accepting connections from DSTN managing units 218 from the different vendors and/or may be capable of initiating connections with multiple embodiments of DSNs 200 or storage networks in general. In that regard, the global coordinator 310 may be capable (e.g., using the analytics agent 330) of extracting coordination message metadata indicating currently configured sampling policy information for multiple vendors and/or DSNs 200 and including the extracted metadata in the data repository 530. The sampling policy information, in turn, may be used to inform existing patterns and identify new recommended telemetry sampling policies based on a larger population. For example, drive performance metadata across multiple clouds may be correlated to further tune an ML model that is used to determine optimal drive metric collection frequency or trace sampling requirements, among other examples.

As indicated by reference number 550, the global coordinator 310 may transmit, and the one or more DSTN managing units 218 may receive, one or more coordination messages that indicates the adjusted sampling policy information for the one or more DSTN managing units 218. Additionally, or alternatively, the global coordinator 310 may report (e.g., using a user interface, such as a web application or similar interface) the adjusted sampling policy information for the one or more DSTN managing units 218. For example, the global coordinator 310 may notify a human operator (e.g., operator 340) of a DSN 200 of a new suggested sampling policy by way of email, phone call, alert, text, or the like.

Additionally, or alternatively, in some implementations the global coordinator 310 may receive (e.g., via the user interface) an indication of an adjustment to one or more sampling policies associated with the adjusted sampling policy information for the one or more DSTN managing unit 218. For example, in connection with a multi-cloud view of metadata from DSNs 200 and all embodiments of a DSN 200 (which can be either hosted on-premises or on the internet as a service), the global coordinator 310 may present the adjusted (e.g., recommended or suggested) sampling policy information for public use or command and as a service (such as via a web application, among other examples). In some implementations, this service may be used by users to analyze and assess differences in recommended sampling policies of storage networks and enable the users to identify if the recommendation should be applied.

As indicated above, FIG. 5 is provided as an example. Other examples may differ from what is described with regard to FIG. 5. The number and arrangement of devices shown in FIG. 5 are provided as an example. In practice, there may be additional devices, fewer devices, different devices, or differently arranged devices than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) shown in FIG. 5 may perform one or more functions described as being performed by another set of devices shown in FIG. 5.

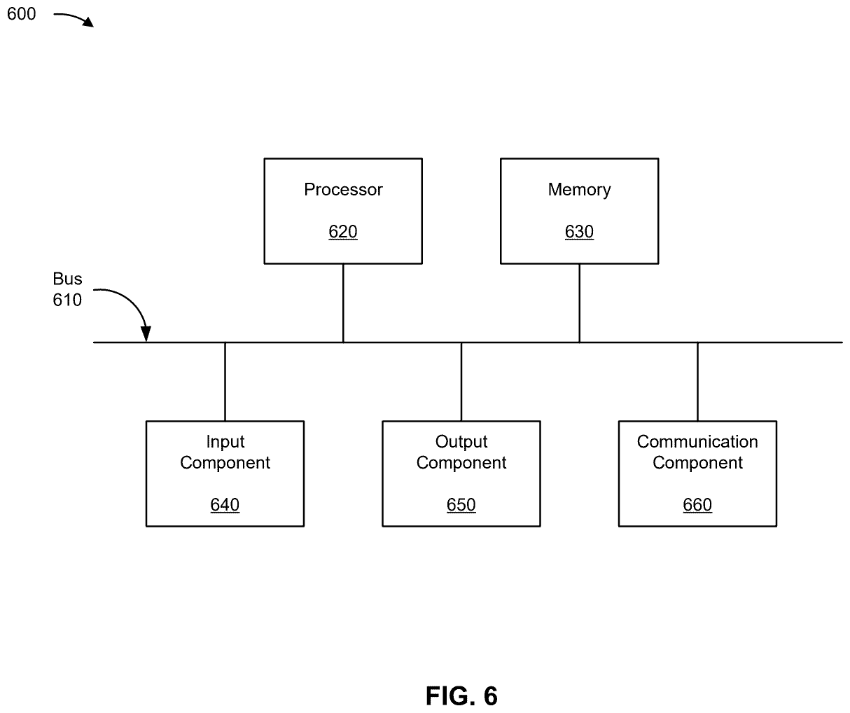

FIG. 6 is a diagram of example components of a device 600 associated with indicating sampling policy information using coordination messages. The device 600 corresponds to one or more of computer 102, end user device 106, remote server 108, a device associated with public cloud 110, a device associated with private cloud 112, computing device 212, computing device 214, computing device 216, DSTN managing unit 218, integrity processing unit 220, storage unit 236, global coordinator 310, and/or analytics agent 330. In some implementations, computer 102, end user device 106, remote server 108, a device associated with public cloud 110, a device associated with private cloud 112, computing device 212, computing device 214, computing device 216, DSTN managing unit 218, integrity processing unit 220, storage unit 236, global coordinator 310, and/or analytics agent 330 include one or more devices 600 and/or one or more components of the device 600. In the example shown in FIG. 6, the device 600 includes a bus 610, a processor 620, a memory 630, an input component 640, an output component 650, and/or a communication component 660.

The bus 610 includes one or more components that enable wired and/or wireless communication among the components of the device 600. The bus 610 couples together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 includes a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 includes one or more processors capable of being programmed to perform one or more operations or processes described elsewhere herein.

The memory 630 includes volatile and/or nonvolatile memory, such as random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). In some implementations, the memory 630 is a non-transitory computer-readable medium. The memory 630 stores information, one or more instructions, and/or software (e.g., one or more software applications) related to the operation of the device 600. In some implementations, the memory 630 includes one or more memories that are coupled (e.g., communicatively coupled) to one or more processors (e.g., processor 620), such as via the bus 610. Communicative coupling between a processor 620 and a memory 630 enables the processor 620 to read and/or process information stored in the memory 630 and/or to store information in the memory 630.

The input component 640 enables the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 enables the device 600 to provide output, such as via a display, a speaker, and/or a light-emitting diode. The communication component 660 enables the device 600 to communicate with other devices via a wired connection and/or a wireless connection. For example, the communication component 660 may include a receiver, a transmitter, a transceiver, a modem, a network interface card, and/or an antenna.

In some implementations, the device 600 performs one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry is used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

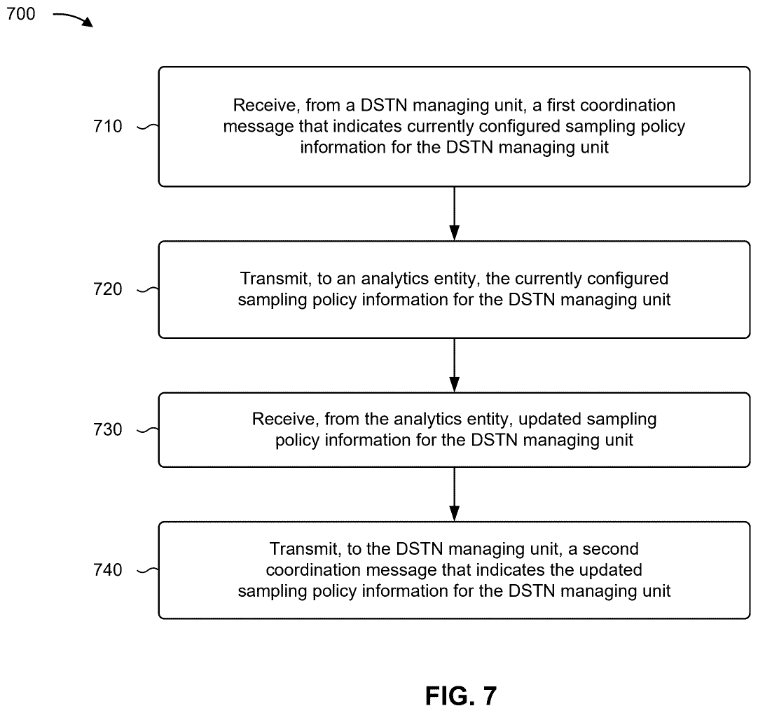

FIG. 7 is a flowchart of an example process 700 associated with indicating sampling policy information using coordination messages. One or more process blocks of FIG. 7 are performed by a global coordinator (e.g., global coordinator 310) and/or by another device or a group of devices separate from or including the global coordinator, such as analytics agent (e.g., analytics agent 330), and/or DSTN managing unit (e.g., DSTN managing unit 218). Additionally, or alternatively, one or more process blocks of FIG. 7 may be performed by one or more components of device 600, such as processor 620, memory 630, input component 640, output component 650, and/or communication component 660.

As shown in FIG. 7, process 700 includes receiving, from a DSTN managing unit, a first coordination message that indicates currently configured sampling policy information for the DSTN managing unit (block 710). For example, the global coordinator may receive, from a DSTN managing unit, a first coordination message that indicates currently configured sampling policy information for the DSTN managing unit, as described above.

As further shown in FIG. 7, process 700 includes transmitting, to an analytics agent, the currently configured sampling policy information for the DSTN managing unit (block 720). For example, the global coordinator may transmit, to an analytics agent, the currently configured sampling policy information for the DSTN managing unit, as described above.

As further shown in FIG. 7, process 700 includes receiving, from the analytics agent, adjusted sampling policy information for the DSTN managing unit (block 730). For example, the global coordinator may receive, from the analytics agent, adjusted sampling policy information for the DSTN managing unit, as described above.

As further shown in FIG. 7, process 700 includes transmitting, to the DSTN managing unit, a second coordination message that indicates the adjusted sampling policy information for the DSTN managing unit (block 740). For example, the global coordinator may transmit, to the DSTN managing unit, a second coordination message that indicates the adjusted sampling policy information for the DSTN managing unit, as described above.

Process 700 may include additional implementations, such as any single implementation or any combination of implementations described below and/or in connection with one or more other processes described elsewhere herein.

In a first implementation, process 700 includes receiving, from one or more other DSTN managing units, one or more other coordination messages that collectively indicate currently configured sampling policy information for the one or more other DSTN managing units, and aggregating, by the global coordinator, the currently configured sampling policy information for the DSTN managing unit and the currently configured sampling policy information for the one or more other DSTN managing units, resulting in aggregated sampling policy information, wherein transmitting the currently configured sampling policy information for the DSTN managing unit includes transmitting the aggregated sampling policy information, and wherein the adjusted sampling policy information for the DSTN managing unit is based on the aggregated sampling policy information.

In a second implementation, alone or in combination with the first implementation, the DSTN managing unit is associated with a first DSN, and at least one other DSTN managing unit, of the one or more other DSTN managing units, is associated with a second DSN different from the first DSN.

In a third implementation, alone or in combination with one or more of the first through second implementations, the DSTN managing unit is associated with a first vendor, and at least one other DSTN managing unit, of the one or more other DSTN managing units, is associated with a second vendor different from the first vendor.

In a fourth implementation, alone or in combination with one or more of the first through third implementations, process 700 includes reporting, using a user interface, the aggregated sampling policy information.

In a fifth implementation, alone or in combination with one or more of the first through fourth implementations, process 700 includes reporting, using a user interface, the adjusted sampling policy information for the DSTN managing unit.

In a sixth implementation, alone or in combination with one or more of the first through fifth implementations, process 700 includes receiving, using the user interface, an indication of an adjustment to one or more sampling policies associated with the adjusted sampling policy information for the DSTN managing unit.

In a seventh implementation, alone or in combination with one or more of the first through sixth implementations, the currently configured sampling policy information indicates at least one of an interval for metric collection, types of metrics collected, a metric collection ratio, a type of metadata for which metrics are to be collected, a type of user for which metrics are to be collected, or a type of operation for which metrics are to be collected.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, or a combination of related and unrelated items), and may be used interchangeably with “one or more. ” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, by a global coordinator and from a distributed storage and task processing network (DSTN) managing unit, a first coordination message that indicates currently configured sampling policy information for the DSTN managing unit;
transmitting, by the global coordinator and to an analytics agent, the currently configured sampling policy information for the DSTN managing unit;
receiving, by the global coordinator and from the analytics agent, adjusted sampling policy information for the DSTN managing unit; and
transmitting, by the global coordinator and to the DSTN managing unit, a second coordination message that indicates the adjusted sampling policy information for the DSTN managing unit.

2. The method of claim 1, further comprising:
receiving, by the global coordinator from one or more other DSTN managing units, one or more other coordination messages that collectively indicate currently configured sampling policy information for the one or more other DSTN managing units; and
aggregating, by the global coordinator, the currently configured sampling policy information for the DSTN managing unit and the currently configured sampling policy information for the one or more other DSTN managing units, resulting in aggregated sampling policy information,
wherein transmitting the currently configured sampling policy information for the DSTN managing unit includes transmitting the aggregated sampling policy information, and
wherein the adjusted sampling policy information for the DSTN managing unit is based on the aggregated sampling policy information.

3. The method of claim 2, wherein the DSTN managing unit is associated with a first distributed storage network (DSN), and
wherein at least one other DSTN managing unit, of the one or more other DSTN managing units, is associated with a second DSN different from the first DSN.

4. The method of claim 2, wherein the DSTN managing unit is associated with a first vendor, and
wherein at least one other DSTN managing unit, of the one or more other DSTN managing units, is associated with a second vendor different from the first vendor.

5. The method of claim 2, further comprising reporting, by the global coordinator and using a user interface, the aggregated sampling policy information.

6. The method of claim 1, further comprising reporting, by the global coordinator and using a user interface, the adjusted sampling policy information for the DSTN managing unit.

7. The method of claim 6, further comprising receiving, by the global coordinator and using the user interface, an indication of an adjustment to one or more sampling policies associated with the adjusted sampling policy information for the DSTN managing unit.

8. The method of claim 1, wherein the currently configured sampling policy information indicates at least one of:
an interval for metric collection,
types of metrics collected,
a metric collection ratio,
a type of metadata for which metrics are to be collected,
a type of user for which metrics are to be collected, or
a type of operation for which metrics are to be collected.

9. A computer system comprising:
a processor set;
one or more computer-readable storage media; and
program instructions stored on the one or more computer-readable storage media to cause the processor set to perform operations comprising:
receiving, from a distributed storage and task processing network (DSTN) managing unit, a first coordination message that indicates currently configured sampling policy information for the DSTN managing unit;
transmitting, to an analytics agent, the currently configured sampling policy information for the DSTN managing unit;
receiving, from the analytics agent, adjusted sampling policy information for the DSTN managing unit; and
transmitting, to the DSTN managing unit, a second coordination message that indicates the adjusted sampling policy information for the DSTN managing unit.

10. The computer system of claim 9, wherein the operations further comprise:
receiving, from one or more other DSTN managing units, one or more other coordination messages that collectively indicate currently configured sampling policy information for the one or more other DSTN managing units; and
aggregating the currently configured sampling policy information for the DSTN managing unit and the currently configured sampling policy information for the one or more other DSTN managing units, resulting in aggregated sampling policy information,
wherein transmitting the currently configured sampling policy information for the DSTN managing unit includes transmitting the aggregated sampling policy information, and
wherein the adjusted sampling policy information for the DSTN managing unit is based on the aggregated sampling policy information.

11. The computer system of claim 10, wherein the DSTN managing unit is associated with a first distributed storage network (DSN), and
wherein at least one other DSTN managing unit, of the one or more other DSTN managing units, is associated with a second DSN different from the first DSN.

12. The computer system of claim 10, wherein the operations further comprise reporting, using a user interface, the aggregated sampling policy information.

13. The computer system of claim 9, wherein the operations further comprise:
reporting, using a user interface, the adjusted sampling policy information for the DSTN managing unit; and
receiving, using the user interface, an indication of an adjustment to one or more sampling policies associated with the adjusted sampling policy information for the DSTN managing unit.

14. The computer system of claim 9, wherein the currently configured sampling policy information indicates at least one of:
an interval for metric collection,
types of metrics collected,
a metric collection ratio,
a type of metadata for which metrics are to be collected,
a type of user for which metrics are to be collected, or
a type of operation for which metrics are to be collected.

15. A computer program product comprising:
one or more computer-readable storage media; and
program instructions stored on the one or more computer-readable storage media to perform operations comprising:
receiving, from a distributed storage and task processing network (DSTN) managing unit, a first coordination message that indicates currently configured sampling policy information for the DSTN managing unit;
transmitting, to an analytics agent, the currently configured sampling policy information for the DSTN managing unit;
receiving, from the analytics agent, adjusted sampling policy information for the DSTN managing unit; and
transmitting, to the DSTN managing unit, a second coordination message that indicates the adjusted sampling policy information for the DSTN managing unit.

16. The computer program product of claim 15, wherein the operations further comprise:
receiving, from one or more other DSTN managing units, one or more other coordination messages that collectively indicate currently configured sampling policy information for the one or more other DSTN managing units; and
aggregating the currently configured sampling policy information for the DSTN managing unit and the currently configured sampling policy information for the one or more other DSTN managing units, resulting in aggregated sampling policy information,
wherein transmitting the currently configured sampling policy information for the DSTN managing unit includes transmitting the aggregated sampling policy information, and
wherein the adjusted sampling policy information for the DSTN managing unit is based on the aggregated sampling policy information.

17. The computer program product of claim 16, wherein the DSTN managing unit is associated with a first distributed storage network (DSN), and
wherein at least one other DSTN managing unit, of the one or more other DSTN managing units, is associated with a second DSN different from the first DSN.

18. The computer program product of claim 16, wherein the operations further comprise reporting, using a user interface, the aggregated sampling policy information.

19. The computer program product of claim 15, wherein the operations further comprise reporting, using a user interface, the adjusted sampling policy information for the DSTN managing unit.

20. The computer program product of claim 19, wherein the operations further comprise receiving, using the user interface, an indication of an adjustment to one or more sampling policies associated with the adjusted sampling policy information for the DSTN managing unit.
